(19) United States
(12) Patent Application Publication
(10) Pub. No.: US 2019/0226551 A1
(43) Pub. Date: Jul. 25, 2019

(54) TORQUE-TRANSMISSION DEVICE, IN PARTICULAR FOR A MOTOR VEHICLE

(71) Applicant: VALEO EMBRAYAGES, Amiens Cedex2 (FR)

(72) Inventors: Rabah ARHAB, Amiens (FR); Daniel FENIOUX, Amiens (FR); Sungchul LEE, Auburn Hills, MI (US); Josip KOVAC, Auburn Hills, MI (US)

(73) Assignee: VALEO EMBRAYAGES, Amiens Cedex2 (FR)

(21) Appl. No.: 16/313,713

(22) PCT Filed: Jun. 26, 2017
(86) PCT No.: PCT/FR2017/051695

§ 371 Date: Dec. 27, 2018

(30) Foreign Application Priority Data
Jun. 28, 2016 (FR) 1656028

(51) Int. Cl. F16F 15/123; F16F 15/14; F16H 45/02

(52) U.S. Cl. CPC F16F 15/12366; F16F 15/12306; F16H 2045/0263; F16H 45/02; F16H 2045/0231; F16F 15/1407

(57) ABSTRACT

The invention relates to a torque-transmission device (1), in particular for a motor vehicle, including a torque-input element (7), intended for being rotatably coupled with a crankshaft of an engine, an intermediate element (19) and a torque-output element (11), intended for being rotatably coupled with a gearbox input shaft, first damping means being mounted between the torque-input element (7) and the intermediate element (19) and second damping means being mounted between the intermediate element (19) and the torque-output element (11), the torque-input element (7), the torque-output element (11) and the intermediate element (19) being capable of pivoting relative to one another about an axis (X), characterised in that the first damping means (20, 21) are capable of exerting a force directed circumferentially or, respectively, a force comprising a radial component, the second damping means (21, 20) being capable of exerting a force comprising a radial component or, respectively, a force directed circumferentially.

The present invention relates to a torque-transmission device, in particular for a motor vehicle.

The torque-transmission device is for example a hydrokinetic clutch, such as for example a torque converter.

Of course, the invention is not limited to a torque converter but can also be applied to a dual mass flywheel, for example.

Patent application EP 2 149 727, in the name of the Applicant, discloses a hydrodynamic torque converter comprising an impeller wheel affixed to a cover integral with a crankshaft, the impeller wheel being able hydrokinetically to rotate a turbine wheel, through a reactor. The turbine wheel is integral with a hub intended to be rotatably coupled to an input shaft of a gear box.

The torque converter also comprises a clutch component whose radially external periphery comprises friction linings.

The clutch component is able to be moved between an engaged position and a disengaged position. In the engaged position, the said friction linings come to rest against the cover, so as to couple in rotation the cover and the hub, in particular through damping means. Thus, in engaged position, the crankshaft and the input shaft of the gear box are rotatably coupled through the damping means. The latter can circumferentially comprise in particular elastic components taking the form of curved springs extending circumferentially.

In the disengaged position, the cover and the hub are rotatably coupled by means of hydrokinetic coupling, i.e. by means of the impeller wheel, the reactor and the turbine wheel.

The damping means with curved springs are able to exert a force directed circumferentially and having a constant of linear stiffness enabling a good filtering of the vibrations and acyclisms of rotation of the engine, but having the defect of generating significant frictions at high drive speed. Indeed, when they are subjected to centrifugal loads, the curved springs are radially plated outside on chutes or a connection component affixed to the clutch component for example, significant frictions then being generated when the springs are deformed under operation.

Patent applications FR 2 716 511 and FR 2 847 631, in the name of the Applicant, each disclose a dual mass flywheel comprising a primary inertia mass, intended to be rotatably coupled to a crankshaft, and a secondary inertia mass, intended to be rotatably coupled to an input shaft of a gear box. The secondary inertia mass is able to pivot about an axis with respect to the primary inertia mass, damping means being mounted between the primary and secondary inertia masses.

The damping means comprise elastic components extending radially in rest position, i.e. when no torque is transmitted through the device, the springs being displaced from their radial position when the primary inertia mass pivots with respect to the secondary inertia mass. In all cases, the said elastic components are able to generate a force comprising a radial component.

Such damping means are more commonly called radial damping means or damping means with radial action.

Such damping means present a stiffness constant continuously increasing with the displacement of the primary inertia mass with respect to the secondary inertia mass, enabling a good filtering regardless of the engine speed. However, such damping means allow only a weak angular displacement of the secondary inertia mass with respect to the primary inertia mass.

The invention aims to supply a torque-transmission device offering good filtration performance regardless of engine speed, while enabling a strong displacement of the torque-input element, which is integral in rotation with the crankshaft, with respect to the torque-output element, which is integral in rotation with the input shaft of the gear box.

For this purpose, it proposes a torque-transmission device, in particular for a motor vehicle, comprising a torque-input element, intended to be rotatably coupled to a crankshaft of an engine, an intermediate element and a torque-output element, intended to be rotatably coupled to an input shaft of a gear box, first damping means being mounted between the torque-input element and the intermediate element and second damping means being mounted between the intermediate element and the torque-output element, the torque-input element, the torque-output element and the intermediate element being able to pivot relative to each another about an axis, characterized in that the first damping means are able to exert a force directed circumferentially, or respectively a force comprising a radial component, the second damping means being able to exert a force comprising a radial component, or respectively a force directed circumferentially.

The torque-transmission device thus comprises two types of damping means arranged in series, i.e. damping means able to exert a force directed circumferentially (damping means with circumferential action) and damping means able to exert a force comprising a radial component (damping means with radial action).

Such damping means offer good filtration performance regardless of the engine speed, while enabling a strong angular displacement of the torque-output element with respect to the torque-input element.

The first damping means, or respectively the second damping means, comprise at least two elastic components with circumferential action, mounted in series through a phasing component, so that the elastic components with circumferential action become deformed in phase with each other.

The torque-transmission device is then of type LTD (Long Travel Damper), as that characteristic makes it possible to further increase the angular displacement between the torque-input element and the torque-output element.

The device can comprise pendular damping means, in order to further improve the filtration capacities.

The pendular damping means can comprise at least one pendular mass mounted in mobile fashion on the intermediate element.

The device can comprise at least one inertial beater, in order to further improve the filtration capacities.

The inertial beater can comprise at least one inertia mass rotatably mounted in oscillating fashion, with respect to the intermediate element, the inertia mass being connected to the intermediate element through elastic means opposing the rotation of the inertia mass with respect to the intermediate element.

The torque-output element can comprise a hub, for example a hub comprising grooves at its radially internal periphery, the said grooves being able to cooperate with complementary grooves of the input shaft of the gear box.

The device can comprise clutch means that are mobile between a disengaged position in which the torque-input element and the torque-output element are rotatably coupled through hydrokinetic coupling means, and an engaged position in which the torque-input element and the torque-output element are rotatably coupled through the first damping means and the second damping means arranged in series through the intermediate element.

The device thereby forms a hydrokinetic clutch. The clutch means make it possible to activate or deactivate the hydrokinetic coupling means.

The hydrokinetic coupling means can comprise an impeller wheel rotatably coupled to the torque-input element, and a turbine wheel, rotatably coupled to the torque-output element.

It will be noted that a hydrokinetic clutch can be a torque converter when the hydrokinetic coupling means comprise an impeller wheel, a turbine wheel and a reactor, or can be a coupler when the hydrokinetic coupling means have no reactor.

The damping means able to exert a force directed circumferentially can be located radially outside the damping means able to exert a force comprising a radial component.

Such a characteristic makes it possible to increase the displacement enabled by the damping means located outside, formed for example by curved elastic components which can have a long length due to their location over a large diameter.

The first and second damping means can be located axially facing each other, in order to limit the axial footprint.

The damping means able to exert a force directed circumferentially can comprise at least one helical compression spring, for example a curved spring.

The damping means able to exert a force comprising a radial component can comprise:
a cylindrical component whose end is connected to the torque-input element, the intermediate element or the torque-output element, the said component being filled with a hydraulic fluid, such as for example oil,
a piston mounted in the component, the said piston being integral with an actuation rod connected to the torque-output element, the intermediate element or the torque-input element, the piston being able to move with respect to the component so that the fluid generates by viscosity a resistant force comprising a radial component,
an elastic component mounted between the body and the piston in order to retract the piston and the body into a radial position.

In this case, the piston can delimit with the body a first radially external chamber and a second radially internal chamber, arranged on both sides of piston, the body comprising a radially external fluid circulation opening, emerging into the first chamber.

In this manner, in operation, when the hydraulic fluid is subjected to centrifugal forces at high engine speed, the said fluid can escape from the first chamber through the aforementioned opening.

The device according to the invention can also comprise one or several of the following characteristics:
the intermediate element is able to pivot with respect to the torque-input element, in opposition to the first damping means,
the torque-output element is able to pivot with respect to the intermediate element, in opposition to the second damping means,
the phasing component is able to pivot with respect to the intermediate element and the torque-input element or respectively the torque-output element,
the body is mounted pivoting on the torque-input element, the intermediate element or the torque-output element,
the shaft is mounted pivoting on the torque-output element, the intermediate element or the torque-input element,
the piston delimits an annular passage with the body, the said annular passage enabling the passage of fluid between the first and second chambers.

The invention will be better understood and other details, characteristics and advantages of the invention will appear upon reading the following description made by way of nonrestrictive example in reference to the attached drawings, in which:

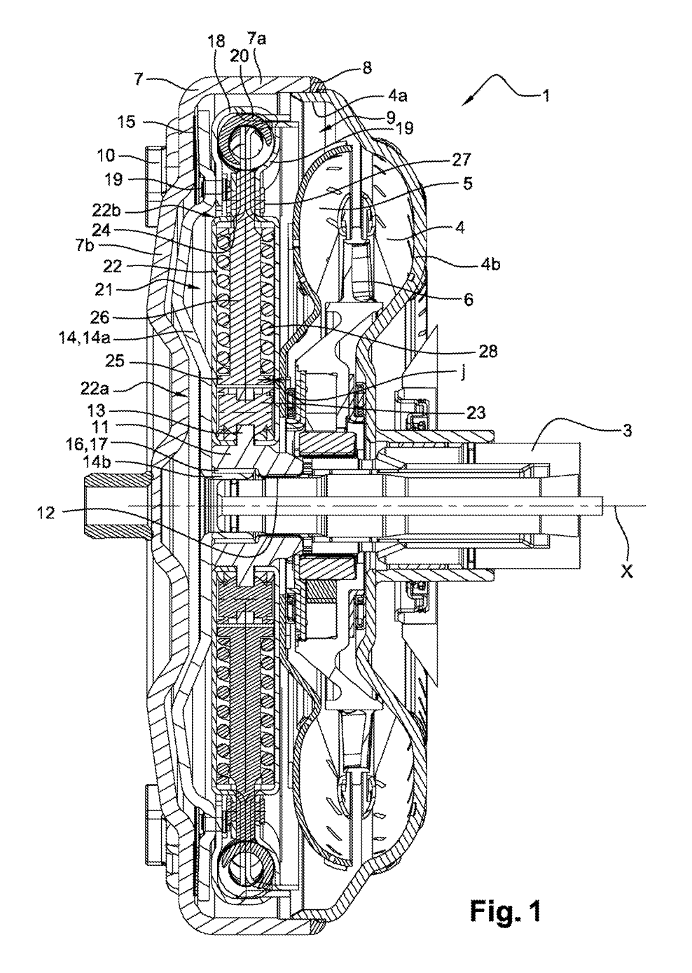

FIG. 1 is an axial cross-section of a torque converter according to one embodiment of the invention,

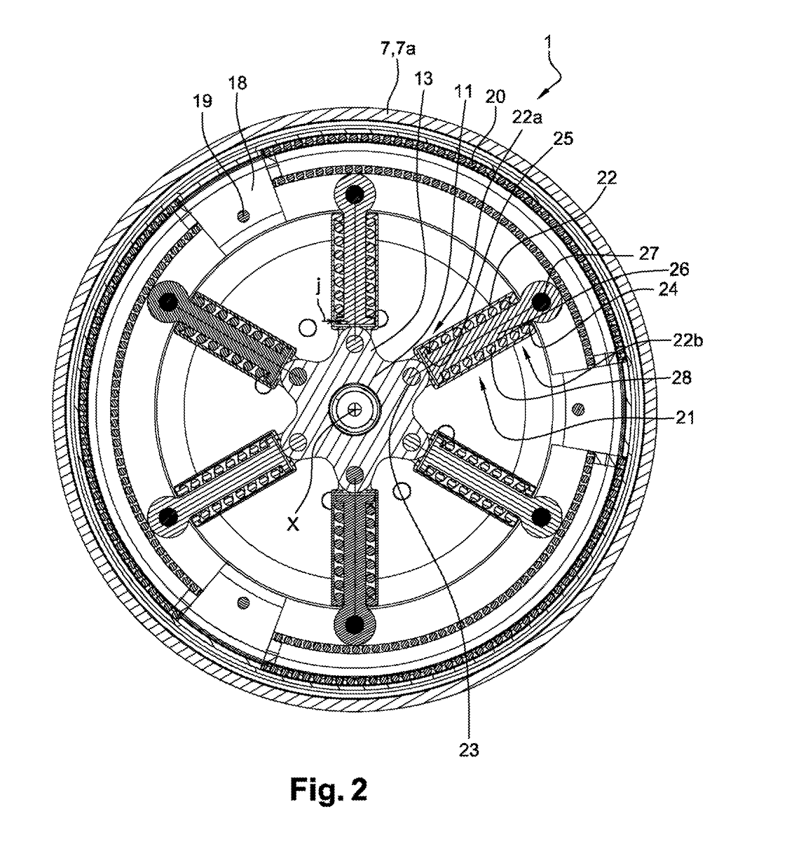

FIG. 2 is a radial cross-section of the torque converter of FIG. 1,

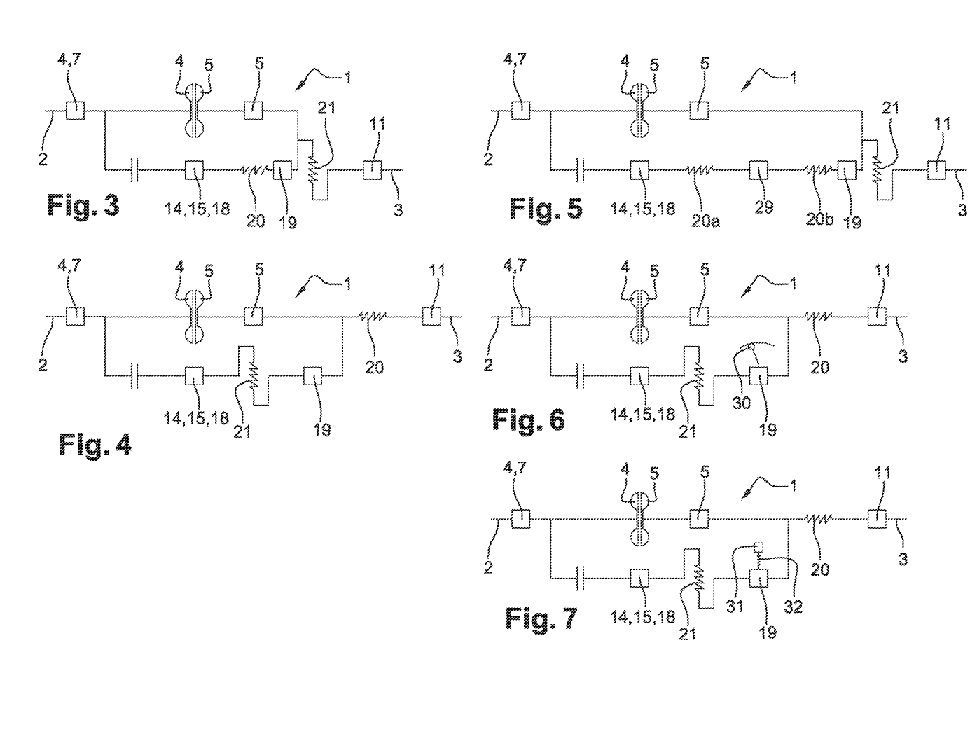

FIG. 3 is a schematic view of the torque converter of FIGS. 1 and 2,

FIGS. 4 to 7 are schematic views of torque converters according to alternative embodiments of the invention.

FIGS. 1 to 3 represent a torque converter 1, in particular for a motor vehicle, according to one embodiment of the invention. It makes it possible to transmit a torque from an output shaft of an internal combustion engine of a motor vehicle, such as for example a crankshaft 2, to an input shaft of a gear box 3. The axle of the torque converter bears the reference X.

In the following, the terms “axial” and “radial” are defined with respect to the axle X.

The torque converter 1 comprises a turbine impeller wheel 4, able hydrokinetically to drive a turbine impeller wheel 5, through a reactor 6.

The impeller wheel 4 is affixed to a cover 7 by welding 8 and delimits with said cover 7 an internal volume 9 housing the impeller wheel 4, the turbine wheel 5 and reactor 6. The impeller wheel 4 comprises a cylindrical part 4a extending from the radially external periphery of a radial part 4b. The cylindrical part 4b of the impeller wheel 4 is affixed to a cylindrical part 7a of the cover 7, the rear end of the aforesaid cylindrical part 4a being prolonged by a radial part 4b extending radially inward. The radial part 4b comprises means of affixing 10 making it possible to rotatably couple the said cover 7 to the crankshaft 2.

The torque converter 1 also comprises a central hub 11 whose radially internal periphery 12 is grooved, of axle X and housed in the internal volume 9. The central hub 11 comprises an annular edge or lobes 13 extending radially outward. Lobes 13 are regularly distributed over the circumference and there are six of them, for example. The turbine wheel 5 is coupled or integral in rotation with the hub 11.

The torque converter 1 also comprises a clutch component 14 comprising a radial part 14a whose radially external periphery comprises friction linings 15 able to come to rest against the radial part 7b of the cover 7. The radially internal periphery of the clutch component 14 comprises a cylindrical part 14b comprising grooves 16 engaged with the grooves 17 of the hub 11, so as to rotatably couple the clutch component 14, the hub 11 and the input shaft of the gear box 3.

At least one connection component 18 is mounted in radially external periphery of the clutch component 14, here three connection components 18 affixed by means of rivets 19 to the clutch component 14, regularly distributed over the circumference.

First damping means are mounted between the connection components 18 and an intermediate element 19 formed for example by one or more annular parts affixed to each other.

The first damping means comprise in particular helical compression springs 20 extending circumferentially, here three in number, such as for example curved springs. The springs with circumferential action 20 are supported, at one end, on the corresponding connection component 18 affixed to the clutch component 14, and at another end, on the intermediate element 19.

Second damping means are mounted between the intermediate component 19 and the hub 11.

The second damping means comprise damping components with radial action 21, i.e. able to exert forces comprising radial components, in particular six damping components with radial action 21 distributed over the circumference.

Each damping component with radial action 21 comprises:
a cylindrical body 22 whose end 22a is mounted pivoting, through an axle 23, a rivet or a pin for example, on the radial lobe 13 of the hub, the said body 22 defining an internal volume filled with a hydraulic fluid such as for example oil, the body comprising an opening 24 at its radially external end 22b,
a piston 25 mounted in the body 22 and delimiting with it two pressure chambers on both sides of the piston 25. Piston 25 is integral with a shaft 26 extending radially outward from the piston and crossing the opening 24. The radially external end of the shaft 26 is mounted pivoting on the intermediate element 19, through an axle, a rivet 27 or a pin for example,
an elastic component 28, for example a helical compression spring, mounted between the body 22 and piston 25, more particularly between the radially external end 22b of the body 22 and the piston 25, in order to radially retract the piston 25 inward, and the shaft 26 and the body 22b in a radial so called rest position.

A calibrated circumferential play j forming a loss of charge extends around the piston 25, between the piston 25 and the body 22, so as to enable the passage of fluid from one pressure chamber to the other. The piston 25 is able to move with respect to the body 22 so that the fluid present in the body 22 generates by viscosity and by passage into the circumferential play j, a resistant force comprising a radial component.

The first damping means 20 are located radially outside the second damping means 21, and axially roughly in the same plane.

The aforementioned damping means 20, 21, the intermediate element 19, the hub 11 and the hydrokinetic coupling means 4, 5, 6 are housed in the internal volume 9 delimited by the cover 7 and the impeller wheel 4.

The clutch component 14 is mobile axially with respect to the hub 11 and the cover 5, and can be actuated by a difference in pressure between pressure chambers delimited on both sides of the clutch component 14. In particular, the clutch component 14 can be actuated between:
an engaged position in which it is rotatably coupled by friction to the cover 7, so that the crankshaft 2 is rotatably coupled to the input shaft 3 of the gear box through the cover 7, the clutch component 14, the connection component 18, the curved elastic components 20, the intermediate element 19, the damping components 21, and the hub 11,
a disengaged position in which it is uncoupled from the cover 7 so that the torque is transmitted from the crankshaft 2 to the input shaft 3 of the gear box through the cover 7, the hydrokinetic coupling means formed by the impeller wheel 4, the turbine wheel 5 and the reactor 6, and by the hub 11.

The internal volume 9 contains the hydraulic fluid such as for example oil, used at the same time for the hydrokinetic coupling between the impeller wheel 4 and the turbine wheel 5 or to actuate the clutch component 14, the said fluid also being able to penetrate or escape from the radially external chamber of the body 22, by the corresponding opening 24.

In operation, the torque-input element formed by the cover 7 pivots with respect to the torque-output element formed by the hub 11. When the clutch component 14 is in engaged position, the intermediate element 19 is then able to pivot with respect to the cover 7 so that the curved elastic components 20 are able to exert a circumferential force. In addition, the intermediate element 19 is then able to pivot with respect to the hub 11, so that the body 22 and the shaft 26 are able to pivot with respect to their respective pivoting axes 23, 27. The piston 25 is then moved along the body 22, in opposition to the force generated by the fluid contained in the body 22 and the retraction force exerted by the straight springs 28, tending to retract the body 22 and the shaft 26 into their radial position.

It will be noted that the forces generated by the damping components 21 is hardly dependent on the engine speed, the radially external openings 24 enabling a correct circulation of the fluid, in particular when it is subjected to centrifugal forces tending to move it outward.

As indicated previously, such a torque converter 1 comprising damping means with circumferential action 20 and damping means with radial action 21 arranged in series, offers good filtration performance regardless of the engine speed, while enabling a strong displacement of the torque-output element 11 with respect to the torque-input element 7.

FIG. 4 schematically illustrates a variant embodiment which differs from the one presented in reference to FIGS. 1 to 3 in that the damping means with circumferential action 20 comprises two groups of elastic components 20a, 20b arranged in series through a phasing component 29, such that the said elastic components 20a, 20b become deformed in phase with each other, during the rotation of the torque-input element 7 with respect to the intermediate element 19, when the clutch component 14 is in engaged position.

FIG. 5 schematically illustrates an alternative embodiment which differs from the one presented in reference to FIGS. 1 to 3 in that the first damping means mounted between the torque-input element, i.e. the cover 7, and the intermediate element 19 are formed by damping components with radial action 21, and the second damping means mounted between the intermediate element 19 and the torque-output element, i.e. the hub 11, are elastic components with circumferential action, such as for example curved springs 20.

FIG. 6 schematically illustrates an alternative embodiment which differs from the one presented in reference to FIG. 5 in that the intermediate element 19 is equipped with pendular damping means 30. More particularly, the pendular damping means comprise at least one pendular mass 30 mounted in mobile fashion on the intermediate element 19, in order to improve the filtration quality of the torque converter 1.

FIG. 7 schematically an alternative embodiment which differs from the one presented in reference to FIG. 5 in that the intermediate element 19 is equipped with an inertial beater. The inertial beater comprises for example an inertia mass 31 mounted in oscillating fashion in rotation, with respect to the intermediate element 19, the inertia mass 31 being connected to the intermediate element 19 through elastic means 32 opposing the rotation of the inertia mass 31 with respect to the intermediate element 19. The use of an inertial beater makes it possible to improve the filtration quality of the torque converter 1.

1.-14. (canceled)

15. A torque-transmission device, in particular for a motor vehicle, comprising:
a torque-input element, intended to be rotatably coupled to a crankshaft of an engine,
an intermediate element and a torque-output element, intended to be rotatably coupled to a gear box input shaft,
first damping means being mounted between the torque-input element and the intermediate element and second damping means being mounted between the intermediate element and the torque-output element, the torque-input element\, the torque-output element and the intermediate element being able to pivot relative to each another about an axle,
wherein the first damping means are able to exert a force directed circumferentially, or respectively a force comprising a radial component, the second damping means being able to exert a force comprising a radial component, or respectively, a force directed circumferentially.

16. The device according to claim 15, wherein the first damping means, or respectively the second damping means, comprise at least two elastic components with circumferential action, mounted in series through a phasing component, so that the elastic components with circumferential action become deformed in phase with each other.

17. The device according to claim 15, further comprising:
pendular damping means.

18. The device according to claim 17, wherein the pendular damping means comprise at least one pendular mass mounted in mobile fashion on the intermediate element.

19. The device according to claim 15, further comprising:
at least one inertial beater.

20. The device according to claim 19, wherein the inertial beater comprises at least one inertia mass mounted rotatably in oscillating fashion, with respect to the intermediate element, the inertia mass being connected to the intermediate element through elastic means opposing the rotation of the inertia mass with respect to the inlet mediate element.

21. The device according to claim 15, wherein the torque-output element comprises a hub.

22. The device according to claim 15, further comprising:
clutching means that are mobile between a disengaged position in which the torque-input element and the torque-output element are rotatably coupled through hydrokinetic coupling means, and an engaged position in which the torque-input element and the torque-output element are rotatably coupled through the first damping means and the second damping means arranged in series through the intermediate element.

23. The device according to claim 22, wherein the hydrokinetic coupling means comprise an impeller wheel rotatably coupled to the torque-input element, and a turbine wheel, rotatably coupled to the torque-output element.

24. The device according to claim 15, wherein the damping means able to exert a force directed circumferentially are radially located outside the damping means able to exert a force comprising a radial component.

25. The device according to claim 15, wherein the first and second damping means are located axially facing each other.

26. The device according to claim 15, wherein the damping means able to exert a force directed circumferentially comprise at least one helical compression spring, for example a curved spring.

27. The device according to claim 15, wherein the damping means able to exert a force comprising a radial component comprise:
a cylindrical body whose end is connected to the torque-input element, the intermediate element or the torque-output element, the said component being filled with a hydraulic fluid such as for example oil,
a piston mounted in the body, the said piston being integral with an actuation rod connected to the torque-output element, the intermediate element or the torque-input element, the piston being able to move with respect to the body so that the fluid generates by viscosity a resistant force comprising a radial component,
an elastic component mounted between the body and the piston in order to retract the piston and the body in a radial position.

28. The device according to claim 27, wherein the piston delimits with the body a first radially external chamber and a second radially internal chamber, arranged on both sides of piston, the body comprising an opening for circulation of the fluid that is radially external, emerging into the first chamber.
